(19) United States
(12) Patent Application Publication
(10) Pub. No.: US 2026/0235287 A1
(43) Pub. Date: Aug. 13, 2026

(54) BURNER ASSEMBLY, GAS TURBINE COMBUSTOR, AND GAS TURBINE

(71) Applicant: MITSUBISHI HEAVY INDUSTRIES LTD., Tokyo (JP)

(72) Inventors: Shinichi FUKUBA, Tokyo (JP); Keisuke MURA, Tokyo (JP); Zhi ZHANG, Tokyo (JP); Taku EGAWA, Tokyo (JP); Kenta TANIGUCHI, Tokyo (JP); Tomo KAWAKAMI, Tokyo (JP)

(21) Appl. No.: 19/471,871

(22) PCT Filed: Apr. 12, 2024
(86) PCT No.: PCT/JP2024/014779

§ 371 Date: Oct. 2, 2025

(30) Foreign Application Priority Data
Apr. 26, 2023 (JP) 2023-072582

(51) Int. Cl. F23R 3/28; F02C 3/04; F23D 14/02; F23D 14/62; F23D 14/82; F23D 23/00

(52) U.S. Cl. CPC F23R 3/28; F02C 3/04; F23D 14/02; F23D 14/62; F23D 14/82; F23D 23/00

(57) ABSTRACT

In a burner assembly, each of a plurality of burners includes at least one fuel nozzle for injecting fuel, and a mixing flow passage into which the fuel injected from the at least one fuel nozzle and air flows. The burner assembly has a first region in which a plurality of the mixing flow passages are arranged collectively when viewed from an extension direction of the mixing flow passages, and a second region in which the number of mixing flow passages per unit area when viewed from the extension direction is smaller than in the first region. The burner assembly is provided, in at least a portion of a region of the second region in which there is no mixing flow passage, with a flow guide that protrudes farther toward an upstream side than an upstream end portion of a flow of air in the mixing flow passages.

### TECHNICAL FIELD

The present disclosure relates to a burner assembly, a gas turbine combustor, and a gas turbine.

The present application claims priority based on Japanese Patent Application No. 2023-072582 filed in Japan on Apr. 26, 2023, the contents of which are incorporated herein by reference.

### BACKGROUND ART

There is a technique for forming a large number of independent small flames via a burner assembly (cluster burner), as a technique for realizing low NOx while having flashback resistance for a fuel (for example, hydrogen) having a high risk of flashback.

In this technique, a plurality of mixing flow paths for mixing the fuel and air are disposed, and a scale of fuel mixing is reduced. In this manner, high mixing performance can be obtained without actively using a vortex flow for mixing the fuel and the air.

PTL 1 discloses a burner assembly for suppressing the flashback while achieving the low NOx. Each burner of the burner assembly includes a fuel nozzle and a mixing flow path through which the fuel and the air flow, and the fuel nozzle includes a protrusion portion protruding to an upstream side in a flow direction of the air with respect to an inlet of the mixing flow path. In addition, a fuel injection hole is formed on a side surface of the protrusion portion, and the fuel injected from the fuel injection hole flows into the inlet of the mixing flow path together with the air such that the fuel and the air are mixed.

### Citation List

### Patent Literature

[PTL 1] Japanese Unexamined Patent Application Publication No. 2019-168198

### SUMMARY OF INVENTION

### Technical Problem

The burner assembly disclosed in PTL 1 has room for further improvement from a viewpoint of suppressing the flashback.

In view of above-described circumstances, an object of at least one embodiment of the present disclosure is to provide a burner assembly, a gas turbine combustor, and a gas turbine, which can suppress flashback.

### Solution to Problem

(1) According to at least one embodiment of the present disclosure, there is provided a burner assembly including a plurality of burners for mixing a fuel and air. In the burner assembly, each of the plurality of burners includes at least one fuel nozzle for injecting the fuel, and a mixing flow path through which the fuel injected from the at least one fuel nozzle and the air flow. When viewed in an extending direction of the mixing flow paths, the burner assembly includes a first region in which a plurality of the mixing flow paths are collectively disposed, and a second region in which the number of the mixing flow paths per unit area when viewed in the extending direction is smaller than the number of the mixing flow paths per unit area in the first region. The burner assembly includes a flow guide protruding to an upstream side of an upstream-side end portion of a flow of the air in the mixing flow path in at least a portion of a region in which the mixing flow path is not present in the second region.
(2) According to at least one embodiment of the present disclosure, there is provided a gas turbine combustor including the burner assembly having the configuration of (1), and a combustion cylinder forming a space in which a flame is formed on a downstream side of the burner assembly.
(3) According to at least one embodiment of the present disclosure, there is provided a gas turbine including a compressor, a gas turbine combustor to which air compressed by the compressor and a fuel are supplied, and configured to generate a combustion gas by combusting the fuel, and a turbine driven by the combustion gas generated in the gas turbine combustor. The gas turbine combustor is the gas turbine combustor having the configuration of (2).

### Advantageous Effects of Invention

According to at least one embodiment of the present disclosure, it is possible to provide a burner assembly, a gas turbine combustor, and a gas turbine, which can suppress flashback.

### BRIEF DESCRIPTION OF DRAWINGS

FIG. 1 is a schematic configuration diagram of a gas turbine according to an embodiment.

FIG. 2 is a cross-sectional view showing a vicinity of a combustor.

FIG. 3 is a perspective view for describing a structure of the combustor.

FIG. 4A is a schematic view when a burner assembly according to one embodiment is viewed from an upstream side in a flow direction of air along a central axis line.

FIG. 4B is a schematic view when a burner assembly according to another embodiment is viewed from the upstream side in the flow direction of the air along the central axis line.

FIG. 5 is a partial schematic perspective view showing a portion of the burner assembly according to the embodiment.

FIG. 6 is a schematic view when a portion of the burner assembly is viewed from the upstream side in the flow direction of the air along the central axis line.

FIG. 7 is a schematic view showing a portion of a B-B cross section in FIG. 6.

FIG. 8 is a schematic view showing a portion of a C-C cross section in FIG. 6.

FIG. 9A is a cross-sectional view taken along line IX-IX in FIG. 4A with regard to the burner assembly according to the embodiment.

FIG. 9B is a view corresponding to a cross-sectional view taken along line IX-IX in FIG. 4A, and shows a burner assembly according to another embodiment.

FIG. 10 is a cross-sectional view taken along line X-X in FIG. 4A.

FIG. 11 is a cross-sectional view taken along line XI-XI line in FIG. 4A.

FIG. 12A is a schematic view of a region XII surrounded by a broken line in FIG. 4A.

FIG. 12B is the same view as FIG. 12A, and is a view showing an example of a case where a plurality of mixing flow paths are disposed in a lattice shape.

FIG. 12C is the same view as FIG. 12A, and shows an example of a case where the plurality of mixing flow paths are disposed in a concentric circular shape.

FIG. 13 is a view showing an example of the burner assembly when a fuel is injected on a downstream side of an inlet of the mixing flow path.

### DESCRIPTION OF EMBODIMENTS

Hereinafter, some embodiments of the present disclosure will be described with reference to the accompanying drawings. However, dimensions, materials, shapes, and relative dispositions of components described as the embodiments or shown in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

In addition, expressions of “being provided with”, “being equipped with”, “including”, or “having” one component are not exclusive expressions excluding the presence of other components.

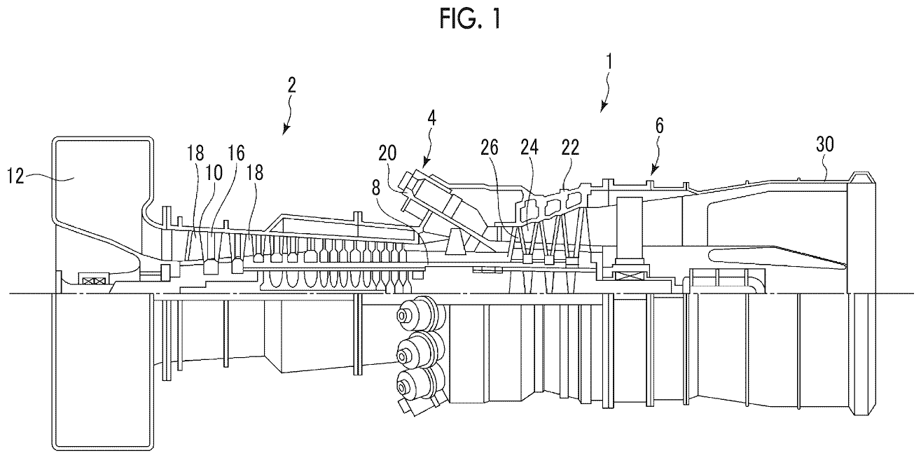

First, a gas turbine, which is an example of an application destination of a burner and a combustor according to some embodiments, will be described with reference to FIG. 1. FIG. 1 is a schematic configuration diagram of a gas turbine according to the embodiment. As shown in FIG. 1, a gas turbine 1 includes a compressor 2 for generating compressed air, a combustor 4 for generating a combustion gas using the compressed air and fuel, and a turbine 6 configured to be rotationally driven by the combustion gas. In a case of the gas turbine 1 for power generation, a generator (not shown) is connected to the turbine 6.

The compressor 2 includes a plurality of stator vanes 16 fixed to a side of a compressor casing 10, and a plurality of rotor vanes 18 embedded in a rotor 8 to be alternately disposed with respect to the stator vanes 16.

Air taken in from an air intake port 12 is fed to the compressor 2. The air passes through the plurality of stator vanes 16 and the plurality of rotor vanes 18, and is compressed to be high-temperature and high-pressure compressed air.

The fuel and the compressed air generated by the compressor 2 are supplied to the combustor 4, and the fuel is combusted in the combustor 4. In this manner, combustion gas serving as a working fluid of the turbine 6 is generated. As shown in FIG. 1, the gas turbine 1 includes a plurality of combustors 4 disposed along a circumferential direction around the rotor 8 inside a casing 20.

The turbine 6 includes a plurality of stator vanes 24 and rotor vanes 26 which are provided in a combustion gas passage formed by a turbine casing 22. The stator vanes 24 and the rotor vanes 26 of the turbine 6 are provided on a downstream side of the combustor 4 with respect to a flow of the combustion gas.

The stator vane 24 is fixed to a side of the turbine casing 22, and a stator vane row is formed by the plurality of stator vanes 24 disposed along the circumferential direction of the rotor 8. In addition, the rotor vane 26 is embedded in the rotor 8, and a rotor vane row is formed by the plurality of rotor vanes 26 disposed along the circumferential direction of the rotor 8. The stator vane row and the rotor vane row are alternately disposed in an axial direction of the rotor 8.

In the turbine 6, the combustion gas flowing into the combustion gas passage from the combustor 4 passes through the plurality of stator vanes 24 and the plurality of rotor vanes 26 to rotationally drive the rotor 8. In this manner, a generator connected to the rotor 8 is driven to generate power. After the turbine 6 is driven, the combustion gas is discharged to an outside via an exhaust chamber 30.

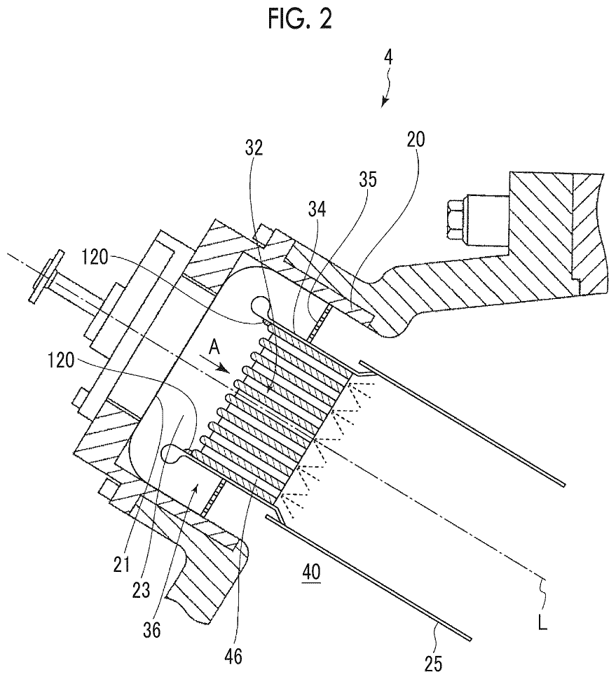

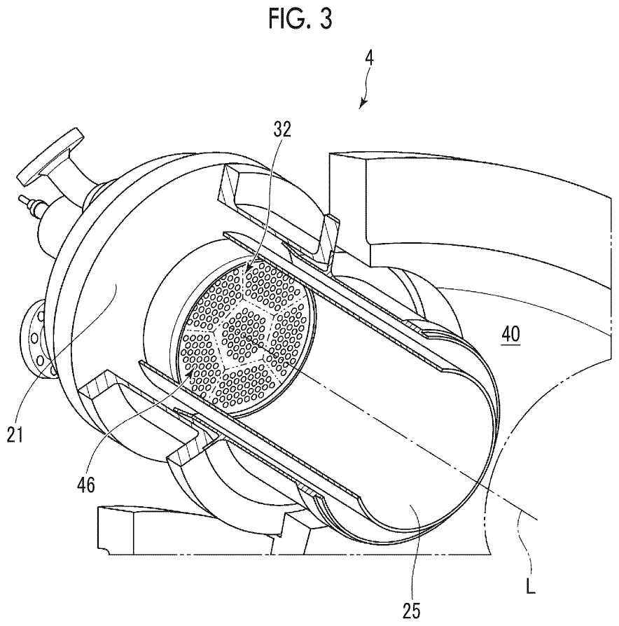

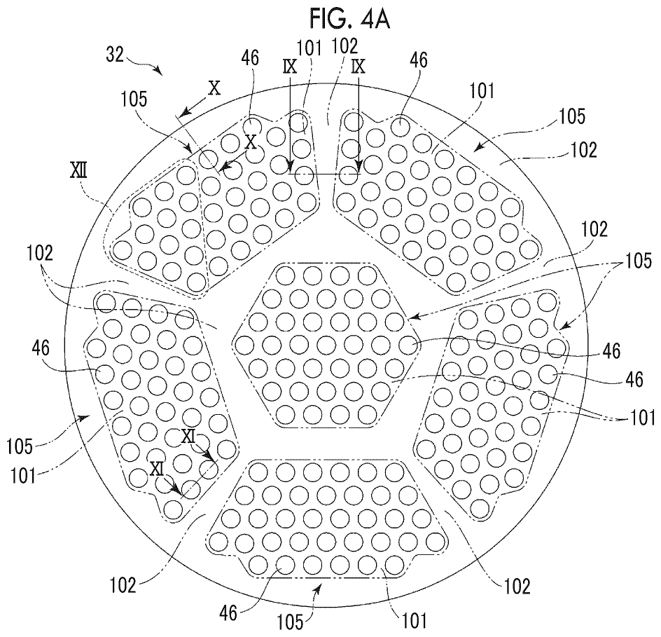

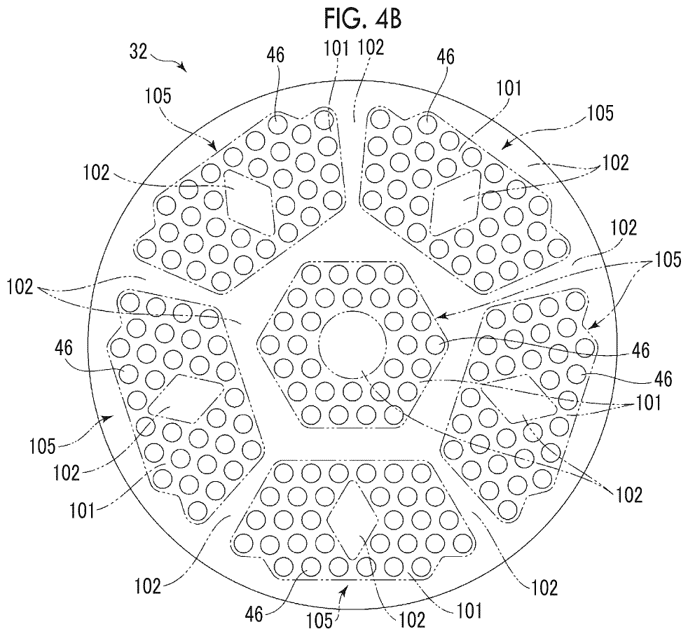

FIG. 2 is a cross-sectional view showing a vicinity of the combustor 4. FIG. 3 is a perspective view for describing a structure of the combustor 4. FIG. 4A is a schematic view when a burner assembly 32 according to the embodiment is viewed from the upstream side in the flow direction of the air along the central axis line L (example of a view in an A direction in FIG. 2). FIG. 4B is a schematic view when the burner assembly 32 according to another embodiment is viewed from an upstream side in a flow direction of the air along a central axis line L (example of the view in the A direction in FIG. 2). In FIGS. 4A and 4B, a protrusion portion 50 and a flow guide 120 (to be described later) are omitted.

The combustor 4 includes a burner assembly 32, a bottomed tubular casing 20 accommodating the burner assembly 32, and a combustion cylinder 25 forming a space in which a flame is formed on a downstream side of the burner assembly 32. In FIG. 2, a one-dot chain line is a central axis line L common to each of the casing 20, the burner assembly 32, and the combustion cylinder 25. The burner assembly 32 is disposed inside the casing 20 of the combustor 4. In an exemplary embodiment shown in the drawing, the burner assembly 32 is held inside a tubular member 34 disposed inside the casing 20, and the tubular member 34 is supported by the casing 20 via a plurality of support portions 35 disposed at an interval around the central axis line L. An air flow path 36 through which the compressed air flowing into a casing 40 flows is formed between the casing 20 and an outer peripheral surface of the tubular member 34 (between the casing 20 and an outer peripheral surface of the burner assembly 32).

The compressed air flowing into the air flow path 36 from the casing 40 flows into a plurality of mixing flow paths 46 (to be described later) provided in the burner assembly 32 together with the fuel through a gap 23 in the axial direction between the burner assembly 32 and a bottom surface 21 of the casing 20. The fuel and the air which are mixed in the burner assembly 32 are ignited by an igniter (not shown), and the flame is formed in the combustion cylinder 25 to generate the combustion gas.

The burner assembly 32 of some embodiments includes a plurality of burners 42 for mixing the fuel and the air as will be described later. Each of the burners 42 includes a mixing flow path 46 (to be described later) through which the fuel and the air flow. In some embodiments, the burner assembly 32 has a circular shape formed around the central axis line L as shown in FIGS. 3, 4A, and 4B, and when viewed along the central axis line L, a plurality of the mixing flow paths 46 are collectively disposed in each of a pentagonal region depicted by a dashed double-dotted line in FIG. 3 around the central axis line L and five regions aligned in the circumferential direction outside the pentagon region to correspond to each side of the pentagon. The plurality of mixing flow paths 46 will be collectively referred to as a cluster 105. In the embodiment shown in FIGS. 3, 4A, and 4B, the burner assembly 32 includes one cluster 105 disposed in a central region around the central axis line L, and five clusters 105 disposed to surround the cluster 105.

In the burner assembly 32 of some embodiments, a region in which the plurality of mixing flow paths 46 are collectively disposed, that is, a region in which the cluster 105 is provided, will be referred to as a first region 101. In addition, in the burner assembly 32 of some embodiments, a region in which the number of the mixing flow paths 46 per unit area is smaller than that of the first region 101 when viewed in an extending direction of the mixing flow path 46, that is, when viewed along the central axis line L, will be referred to as a second region 102.

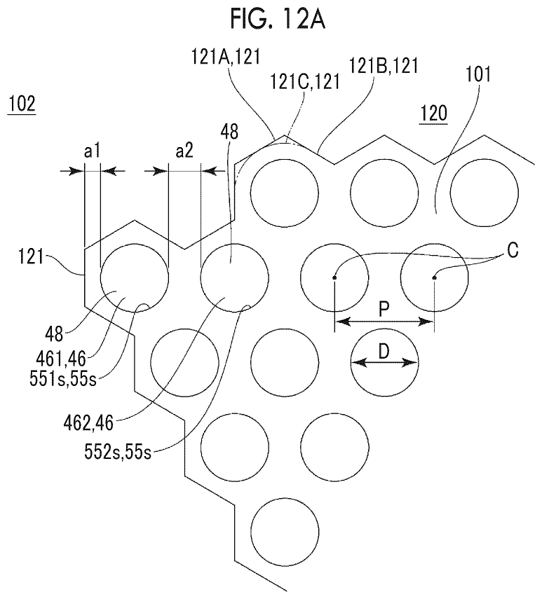

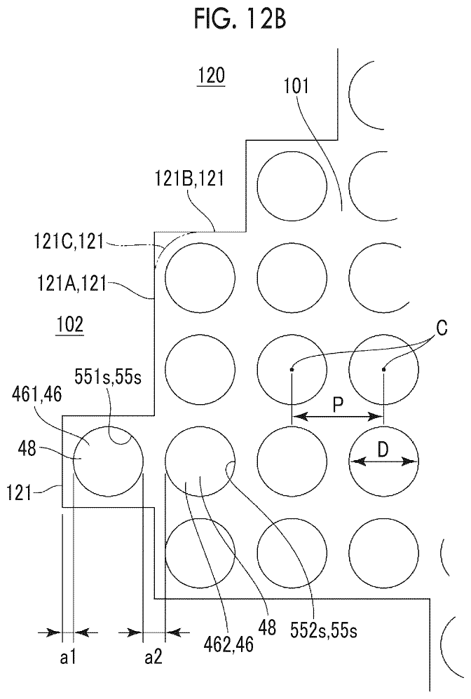

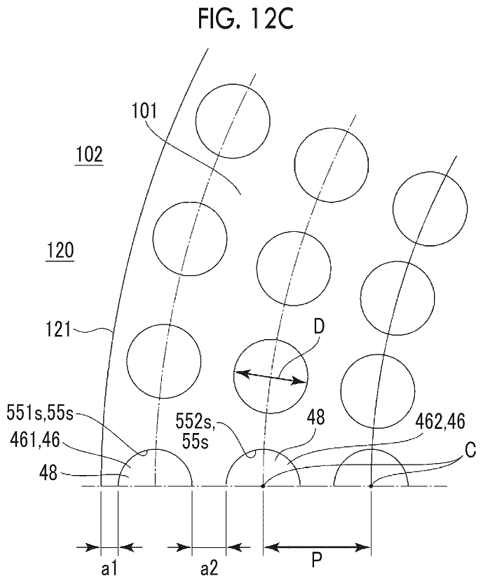

The second region 102 is a region in which a separation distance P between a center position C (refer to FIGS. 12A, 12B, and 12C to be described later) of the mixing flow path 46 in two mixing flow paths 46 adjacent to each other when viewed in the extending direction of the mixing flow path 46 is equal to or more than twice an inner diameter D of the mixing flow path 46.

In the embodiment shown in FIG. 4A, the second region 102 is a region between the adjacent clusters 105 and an outer region in a radial direction around the central axis line L with respect to five clusters 105 disposed apart from each other in the circumferential direction around the central axis line L.

In the embodiment shown in FIG. 4B, the second region 102 is present not only in the region between the adjacent clusters 105 and the outer region in the radial direction around the central axis line L with respect to the five clusters 105 disposed apart from each other in the circumferential direction around the central axis line L, but also inside each first region 101.

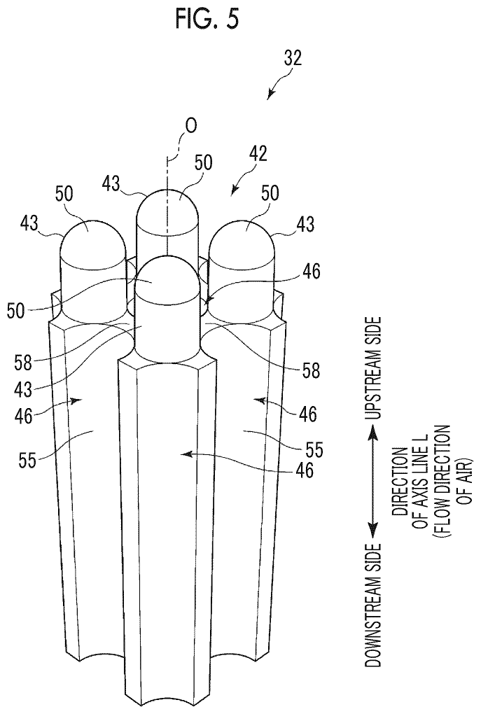

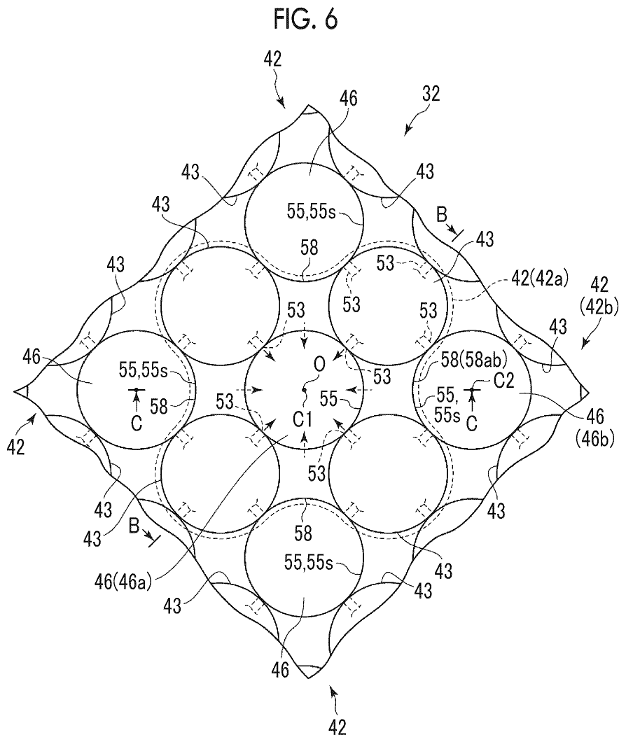

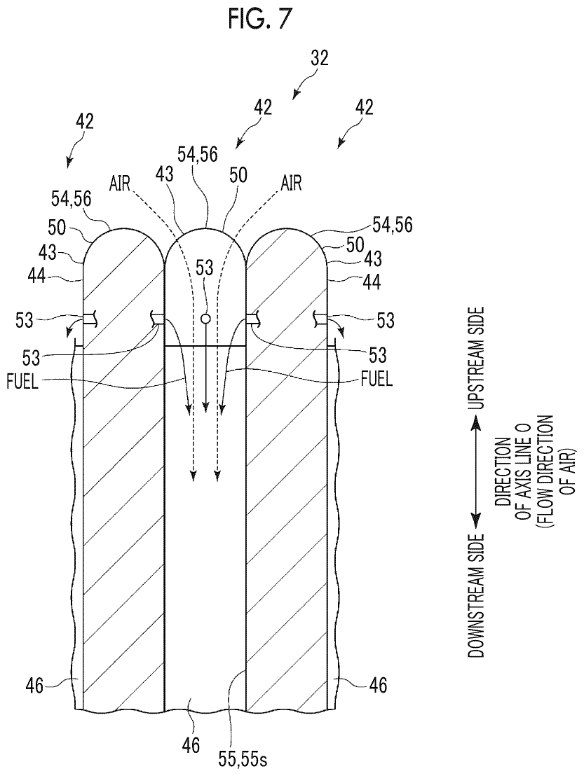

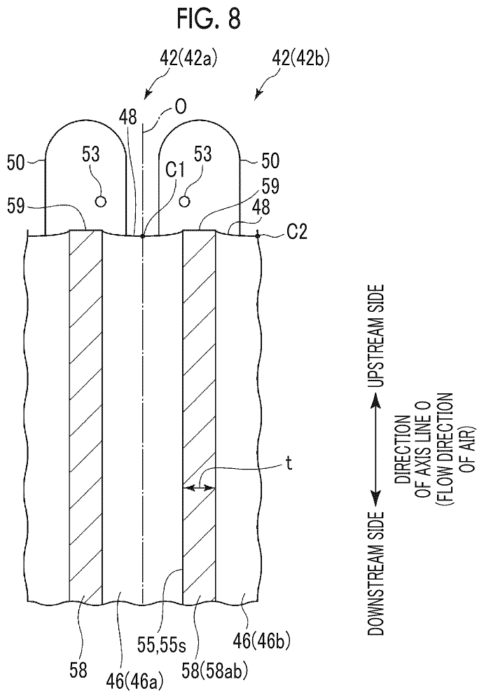

FIG. 5 is a partial schematic perspective view showing a portion of the burner assembly 32 according to the embodiment. FIG. 6 is a schematic view when a portion of the burner assembly 32 is viewed from the upstream side in the flow direction of the air along the central axis line L (example of a view in the A-direction in FIG. 2). FIG. 7 is a schematic view showing a portion of a B-B cross section in FIG. 6. FIG. 8 is a schematic view showing a portion of a C-C cross section in FIG. 6. In FIGS. 5 to 8, the first region 101 is shown.

For example, as shown in FIG. 5 or 6, the burner assembly 32 includes the plurality of burners 42 for mixing the fuel and the air.

For example, as shown in any of FIGS. 5 to 7, each of the burners 42 includes a plurality of fuel nozzles 43 for injecting the fuel, and the mixing flow path 46 into which the fuel injected from the plurality of fuel nozzles 43 and the compressed air supplied from the casing 40 flow (refer to FIGS. 1 to 3). In an exemplary form shown in the drawing, each of the burners 42 includes one mixing flow path 46 and four fuel nozzles 43 disposed around the one mixing flow path 46, and the fuel is injected to the one mixing flow path 46 from the four fuel nozzles 43 around the one mixing flow path 46. In other words, four mixing flow paths 46 are disposed around one fuel nozzle 43, and one fuel nozzle 43 injects the fuel into the four mixing flow paths 46.

Each of the mixing flow paths 46 is formed as through-holes extending parallel to each other, and a central axis line O of each of the mixing flow paths 46 extends in a direction along the central axis line L of the casing 20. In the exemplary form shown in the drawing, the central axis line O of each of the mixing flow paths 46 and the central axis line L of the casing 20 are parallel to each other.

### Fuel Nozzle 43

For example, as shown in FIG. 7, each of the fuel nozzles 43 includes a protrusion portion 50 protruding to the upstream side in the flow direction of the air with respect to an inlet 48 of the mixing flow path 46. In addition, each of the fuel nozzles 43 includes a plurality of fuel injection holes 53 formed on a side surface 44 of the protrusion portion 50. In the exemplary form shown in FIG. 6, on the side surface 44 of the protrusion portion 50, four fuel injection holes 53 are formed at positions corresponding to the four mixing flow paths 46 around the protrusion portion 50. Each of the fuel injection holes 53 may extend in a direction orthogonal to the central axis line O to inject the fuel toward the central axis line O of the mixing flow path 46, or may extend in an oblique direction with respect to the direction orthogonal to the central axis line O.

For example, as shown in FIG. 7, a top surface 54 of the protrusion portion 50 (end surface of the protrusion portion 50 in the direction of the axis line O, that is, a tip of the protrusion portion 50) includes a convex curved surface 56. In the exemplary form shown in the drawing, the entire top surface 54 of the protrusion portion 50 is formed by the convex curved surface 56 that is smoothly curved. For example, the top surface 54 of the protrusion portion 50 may be formed in a streamline shape.

### Flow Path Wall 55

For example, as shown in FIGS. 6 and 8, a flow path wall 55 forming the mixing flow path 46 is formed in a tubular shape such that the mixing flow path 46 having a circular cross section is defined inward, and functions as a mixing pipe for mixing the fuel and the air. Hereinafter, for example, as shown in FIG. 6, any two burners 42 in which the mixing flow paths 46 are closest to each other, in the plurality of burners 42, will be referred to as a first burner 42 (42a) and a second burner 42 (42b) for convenience. As shown in FIGS. 6 and 8, the flow path wall 55 forming the mixing flow path 46 (46a) of the first burner 42a and the flow path wall 55 forming the mixing flow path 46 (46b) of the second burner 42b share a bulkhead portion 58 (58ab) that divides the mixing flow path 46a of the first burner 42a and the mixing flow path 46b of the second burner 42b. In the exemplary form shown in FIG. 6, the flow path wall 55 of the mixing flow path 46 shares the bulkhead portion 58 with each of the flow path walls 55 of the plurality of mixing flow paths 46 (four mixing flow paths 46 in the form shown in the drawing) around the mixing flow path 46.

In addition, as shown in FIG. 8, a thickness t of the bulkhead portion 58ab in the C-C cross section of a burner assembly 32A is constant in the direction along the central axis line O of the first burner 42a. In addition, an upstream-side end surface 59 in the flow direction of the air in the bulkhead portion 58ab is formed in a planar shape. In addition, as shown in FIG. 6, the thickness t of the bulkhead portion 58ab increases as the bulkhead portion 58ab is separated from the C-C cross section. As shown in FIGS. 6 and 8, the C-C cross section is a cross section (first cross section) passing through a center C1 of the inlet 48 of the mixing flow path 46a of the first burner 42a and a center C2 of the inlet 48 of the mixing flow path 46b of the second burner 42b and extending along the central axis line O of the mixing flow path 46 of the first burner 42a.

### Regarding Operational Effect of Burner Assembly 32

In the burner assembly 32 configured in this way, the compressed air flowing into the air flow path 36 from the casing 40 flows through the gap 23 in the axial direction between the burner assembly 32 and a bottom surface 21 of the casing 20, and flows into each of the plurality of mixing flow paths 46 provided in each of the plurality of burners 42 of the burner assembly 32.

As shown in FIG. 7, the air flowing toward the mixing flow path 46 flows to the downstream side along the side surface 44 while flowing inward in the radial direction along the convex curved surface 56 of the protrusion portion 50 when the air flows into the mixing flow path 46.

The fuel is injected into the mixing flow path 46 from the fuel injection hole 53 formed on the side surface 44 of the protrusion portion 50 protruding inward in the radial direction.

The air flowing along the side surface 44 of the protrusion portion 50 flows into the mixing flow path 46 to enter between the fuel injected from the fuel injection hole 53 and a wall surface 55s of the flow path wall 55 of the mixing flow path 46. Therefore, a region having a high fuel concentration is less likely to be formed in the vicinity of the wall surface 55s of the flow path wall 55. As a result, the risk of flashback, which is backfire from an outlet 47 of the mixing flow path 46, can be reduced.

Furthermore, in the burner assembly 32 according to some embodiments, the risk of flashback is further reduced by providing a flow guide 120 (to be described below).

### Regarding Flow Guide 120

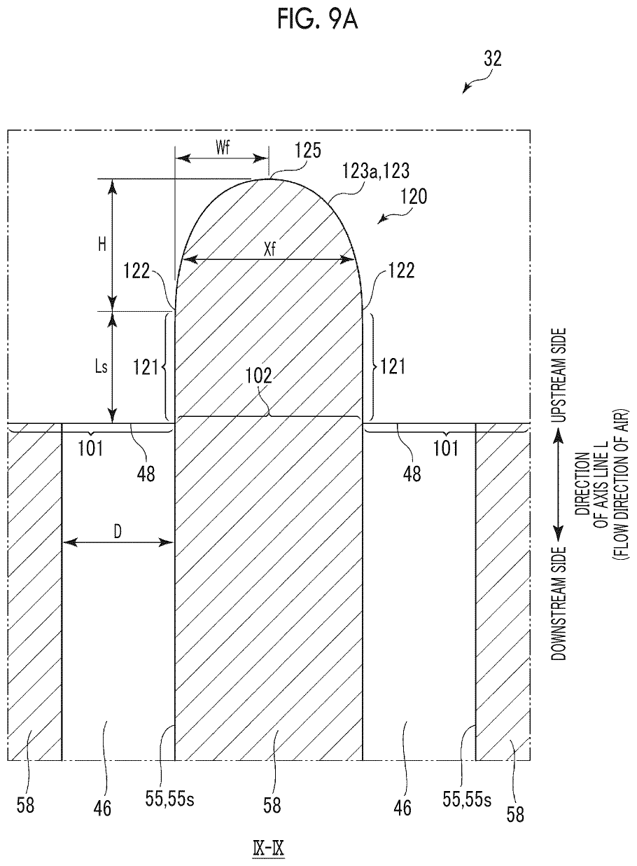

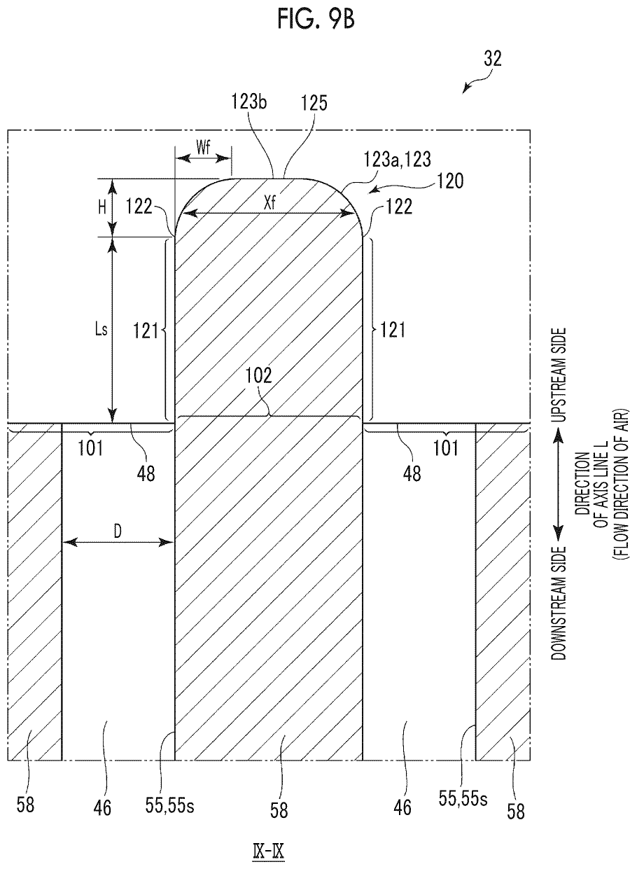

FIG. 9A is a cross-sectional view taken along line IX-IX in FIG. 4A with regard to the burner assembly 32 according to the embodiment.

FIG. 9B is a view corresponding to a cross-sectional view taken along line IX-IX in FIG. 4A, and shows the burner assembly 32 according to the other embodiment.

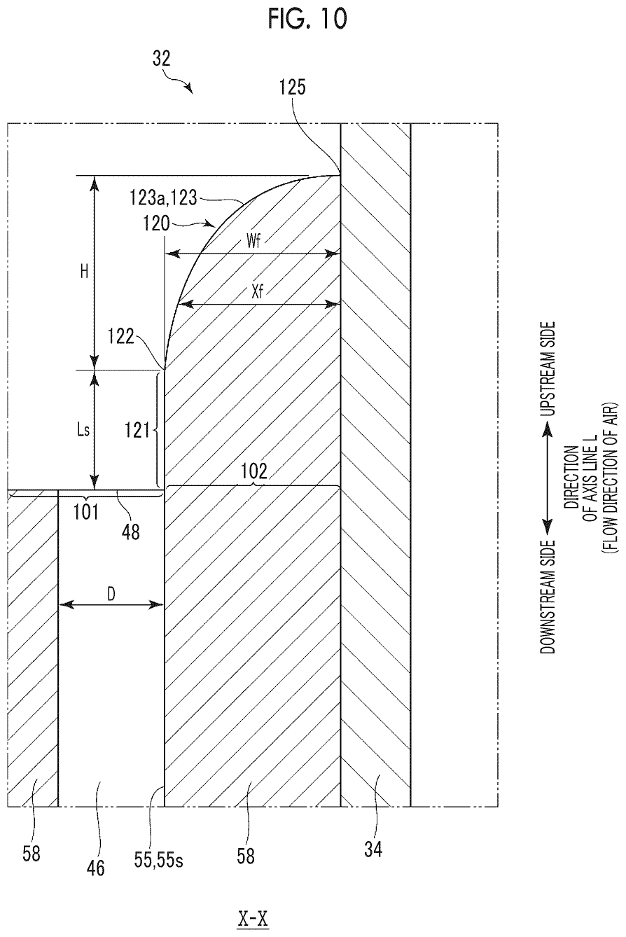

FIG. 10 is a cross-sectional view taken along line X-X in FIG. 4A.

In the burner assembly 32 according to some embodiments, at least a portion of the region where the mixing flow path 46 is not present in the second region 102 includes the flow guide 120 protruding to the upstream side of the upstream-side end portion (inlet 48) of the air flow in the mixing flow path 46.

The air flowing toward the mixing flow path 46 flows to be separated to each mixing flow path 46 as the air flows closer to the inlet 48 of the mixing flow path 46. In this case, a velocity component in a direction orthogonal to the extending direction of the central axis line L is assigned to the air flowing in a space in which the region where the mixing flow path 46 is not provided is projected to the upstream side when viewed along the central axis line L such that the air flows toward the mixing flow path 46 close to the region. The velocity component in the direction orthogonal to the central axis line L tends to increase as a size of the region where the mixing flow path is not provided increases when viewed along the central axis line L. Therefore, when the region where the mixing flow path 46 is not provided increases when viewed along the central axis line L, an inward velocity component in the radial direction of the mixing flow path 46 from the wall surface 55s of the mixing flow path 46 increases when the air flows toward the mixing flow path 46 close to the region, or the air is separated from the wall surface 55s in the region close to the inlet 48 in the mixing flow path 46. In this manner, the flow velocity of the air in the extending direction of the central axis line L decreases in the region close to the wall surface 55s of the mixing flow path 46. As a result, a region having a relatively high fuel concentration is likely to be formed in the region close to the wall surface 55s of the mixing flow path 46, thereby creating a possibility that the risk of flashback increases.

According to the burner assembly 32 according to some embodiments, since the flow guide 120 is provided, compared to a case where the flow guide 120 is not provided, the air is guided to flow to each mixing flow path 46 on the further upstream side. Therefore, it is possible to suppress the inward velocity component in the radial direction of the mixing flow path 46 from the wall surface 55s of the mixing flow path 46 when the air reaches the inlet 48 of the mixing flow path 46, or it is possible to suppress separation of the air from the wall surface 55s in the region close to the inlet 48 in the mixing flow path 46. In this manner, in the region close to the wall surface 55s of the mixing flow path 46, the flow velocity of the air in the extending direction of the central axis line L is less likely to decrease, and a region having the relatively high fuel concentration is less likely to be formed in the region close to the wall surface 55s of the mixing flow path 46. Therefore, the risk of flashback can be reduced.

The combustor 4 according to at least one embodiment of the present disclosure includes the burner assembly 32 described above and the combustion cylinder 25 forming a space in which a flame is formed on the downstream side of the burner assembly 32.

In this manner, the risk of flashback can be suppressed, and the combustor 4 can be stably used.

The gas turbine 1 according to at least one embodiment of the present disclosure includes the compressor 2, the combustor 4 to which the air compressed by the compressor 2 and the fuel are supplied, and configured to generate the combustion gas by combusting the fuel, and the turbine 6 driven by the combustion gas generated in the combustor 4. The combustor 4 is the combustor 4 described above.

In this manner, the risk of flashback can be suppressed, and the gas turbine 1 can be stably operated.

### Regarding Second Region 102

In the burner assembly 32 according to some embodiments, as described above, the second region 102 is a region in which the separation distance P between the center position C (refer to FIGS. 12A, 12B, and 12C to be described later) of the mixing flow path 46 in the two adjacent mixing flow paths 46 when viewed along the central axis line L is equal to or more than twice the inner diameter D of the mixing flow path 46.

A region in which the separation distance P between the center position C of the mixing flow path in the two adjacent mixing flow paths 46 when viewed along the central axis line L is equal to or more than twice the inner diameter D of the mixing flow path 46 is a region in which a size thereof is equal to or more than the inner diameter D of the mixing flow path 46. Therefore, the mixing flow path 46 can be disposed in the region unless there is another reason. Therefore, the second region 102 is a region in which an interval (separation distance P) between the adjacent mixing flow paths 46 is relatively wider than that of the first region 101. Therefore, since the flow guide 120 is provided in the second region 102 in which the interval between the adjacent mixing flow paths 46 is relatively wider than that of the first region 101, the flow guide 120 can be efficiently provided in a region where a high operational effect of the flow guide 120 is expected.

The burner assembly 32 according to some embodiments may have a plurality of the first regions 101. The second region 102 may include a region between the plurality of first regions 101. As described above, for example, in the burner assembly 32 shown in FIGS. 4A and 4B, the burner assembly 32 includes one cluster 105 disposed in a central region around the central axis line L and five clusters 105 disposed to surround the cluster 105. In the embodiment shown in FIGS. 4A and 4B, the second region 102 is present in a region between the adjacent clusters 105 and an outer region in the radial direction around the central axis line L with respect to the five clusters 105 disposed apart from each other in the circumferential direction around the central axis line L.

In this manner, as in the burner assembly 32 shown in FIG. 4A, in a multi-cluster burner having a plurality of segments in which the first region 101 is set as one segment of the cluster burner, the flow guide 120 can be provided in the region between the segments. In this manner, since the flow guide 120 is provided in a dead space between the segments, the risk of flashback in the mixing flow path 46 in the vicinity of the dead space can be reduced.

In the burner assembly 32 according to some embodiments, the second region 102 may be present inside the first region 101 as shown in FIG. 4B.

In this manner, the flow guide 120 can also be provided in the second region 102 present inside the first region 101. In this manner, since the flow guide 120 is provided in the dead space inside the first region 101, the risk of flashback in the mixing flow path 46 in the vicinity of the dead space can be reduced.

### Regarding Shape of Flow Guide 120

In the burner assembly 32 according to some embodiments, the flow guide 120 may have a linear portion 121 extending in a linear shape along the extending direction of the central axis line L. A length Ls of the linear portion 121 along the extending direction may be equal to or larger than 0.5 times the inner diameter D of the mixing flow path 46.

In this manner, since the air can be effectively rectified by the flow guide 120, the risk of flashback can be effectively reduced.

In the burner assembly 32 according to some embodiments, as shown in FIGS. 9A, 9B, and 10, the flow guide 120 may include the linear portion 121, and a tip portion 123 formed such that a dimension Xf in a direction orthogonal to the extending direction of the central axis line L decreases toward the upstream side on the upstream side of the linear portion 121.

In this manner, since the flow guide 120 includes the tip portion 123, the air can be more effectively rectified. Therefore, the risk of flashback can be effectively further reduced.

A shape of the tip portion 123 may be a shape in which a shape of a surface 123a appearing in the cross section taken along the extending direction of the central axis line L is formed by a curved surface convex toward the outside of the tip portion 123, as shown in FIG. 9A. In addition, the shape of the tip portion 123 may be a shape in which the shape of the surface 123a appearing in the cross section taken along the extending direction of the central axis line L has a linear portion 123b extending in a direction (in the example shown in FIG. 9B, a direction orthogonal to the extending direction of the central axis line L) intersecting the extending direction of the central axis line L at a top portion 125, as shown in FIG. 9B. In this case, as shown in FIG. 9B, the linear portion 123b and the linear portion 121 may be gently connected by a curve convex toward the outside of the tip portion 123.

In the burner assembly 32 according to some embodiments, as shown in FIGS. 9A, 9B, and 10, in the cross section taken along the extending direction of the central axis line L, a distance H in the extending direction of the central axis line L from the top portion 125 located on the most upstream side in the tip portion 123 to a position 122 on the most upstream side in the linear portion 121 may be equal to or larger than a distance Wf in a direction orthogonal to the extending direction from the top portion 125 to the linear portion 121 when viewed in the extending direction.

In this manner, the length (distance H) of the tip portion 123 in the extending direction can be secured, and the inward velocity component in the radial direction of the mixing flow path 46 in the air flowing along the surface 123a of the tip portion 123 from the tip portion 123 to the linear portion 121 can be reduced. Therefore, the risk of flashback can be reduced.

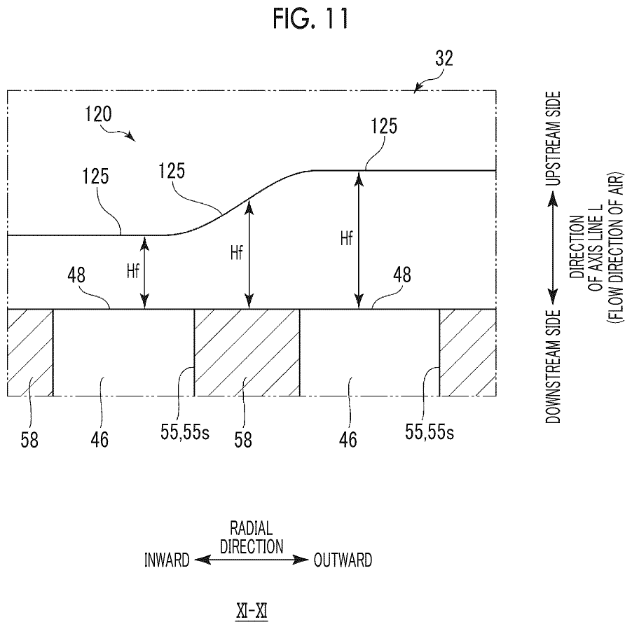

FIG. 11 is a cross-sectional view taken along line XI-XI in FIG. 4A.

In the burner assembly 32 according to some embodiments, the flow guide 120 may have a different protruding amount Hf to the upstream side from the inlet 48 of the mixing flow path 46, depending on a position in the radial direction around the central axis line L.

In this manner, the protruding amount Hf to the upstream side can be appropriately adjusted, depending on the position in the radial direction around the central axis line L.

In the example shown in FIGS. 4A and 11, a dimension in the circumferential direction of the second region 102 interposed between the first regions 101 adjacent to each other in the circumferential direction around the central axis line L gradually increases outward in the radial direction around the central axis line L, and the protruding amount Hf of the flow guide 120 is larger in an outer region in the radial direction than in an inner region in the radial direction around the central axis line L.

An increase rate of the dimension in the circumferential direction of the second region 102 with respect to the distance in the radial direction from the central axis line L may be constant as shown in FIG. 4A, or may be changed, depending on the distance in the radial direction from the central axis line L.

In the example shown in FIG. 11, the protruding amount Hf is constant regardless of the position in the radial direction in a relatively inner region in the radial direction in FIG. 11 and a relatively outer region in the radial direction, and the protruding amount Hf increases outward in the radial direction in a region between the relatively inner region and the relatively outer region in the radial direction in FIG. 11.

However, the protruding amount Hf may be changed over the entire region within an extending range in the radial direction of the flow guide 120.

In addition, contrary to the above description, the dimension in the circumferential direction of the second region 102 may be smaller in the outer region in the radial direction than in the inner region in the radial direction around the central axis line L.

Similarly, contrary to the above description, the protruding amount Hf of the flow guide 120 may be smaller in the outer region in the radial direction than in the inner region in the radial direction around the central axis line L.

### Positional Relationship Between Linear Portion 121 and Wall Surface 55s of Mixing Flow Path 46

FIG. 12A is a schematic view for describing a positional relationship between the linear portion 121 of the flow guide 120 and the mixing flow path 46 in a region XII surrounded by a broken line in FIG. 4A. For convenience of description, FIG. 12A shows a posture in which the region XII is rotated and moved in a clockwise direction such that some of the mixing flow paths 46 are aligned in a left-right direction shown in the drawing.

The plurality of mixing flow paths 46 shown in FIGS. 4A and 12A are disposed at the same positions as those in closest packing.

FIG. 12B is the same view as FIG. 12A and is a view showing an example of a case where the plurality of mixing flow paths 46 are disposed in a lattice shape.

FIG. 12C is the same view as FIG. 12A and is a view showing an example of a case where the plurality of mixing flow paths 46 are disposed in a concentric circular shape.

As shown in FIGS. 12A to 12C, in the burner assembly 32 according to some embodiments, when viewed in the extending direction of the central axis line L, a distance al between the linear portion 121 and a first inner peripheral surface 551s as the wall surface 55s of a first mixing flow path 461 as the mixing flow path 46 adjacent to the linear portion 121 may be equal to or larger than 0.4 times and equal to or smaller than 0.6 times a distance a2 between the first inner peripheral surface 551s and a second inner peripheral surface 552s as the wall surface 55s of a second mixing flow path 462 as the mixing flow path 46 adjacent to the first mixing flow path 461.

The flow guide 120 is not provided over the entire periphery along a peripheral edge of the inlet 48 of the first mixing flow path 461 when viewed in the extending direction of the central axis line L, but is provided only in a portion of the peripheral edge of the inlet 48 of the first mixing flow path 461. Therefore, distribution of a flow rate of the air flowing into the first mixing flow path 461 when viewed in the extending direction of the central axis line L is affected by the length of the distance al between the linear portion 121 and the first inner peripheral surface 551s of the first mixing flow path 461.

For example, when the distance al between the linear portion 121 and the first inner peripheral surface 551s of the first mixing flow path 461 is small, the flow rate of the air in the region close to the linear portion 121 when viewed in the extending direction of the central axis line L is smaller than the flow rate of the air in a region separated from linear portion 121 when viewed in the extending direction of the central axis line L, and a deviation occurs in the flow velocity of the air flowing through the first mixing flow path 461, depending on the position in the circumferential direction of the first mixing flow path 46.

On the contrary, when the distance al between the linear portion 121 and the first inner peripheral surface 551s of the first mixing flow path 461 is large, the flow rate of the air in the region close to the linear portion 121 when viewed in the extending direction of the central axis line L is larger than the flow rate of the air in the region separated from linear portion 121 when viewed in the extending direction of the central axis line L, and a deviation occurs in the flow velocity of the air flowing through the mixing flow path 46, depending on the position in the circumferential direction of the first mixing flow path 461.

According to the burner assembly 32 according to some embodiments, the distance al between the linear portion 121 and the first inner peripheral surface 551s of the first mixing flow path 461 adjacent to the linear portion 121 when viewed in the extending direction of the central axis line L is equal to or larger than 0.4 times and equal to or smaller than 0.6 times the distance a2 between the first inner peripheral surface 551s and the second inner peripheral surface 552s of the second mixing flow path 462 adjacent to the first mixing flow path 461. Therefore, it is possible to reduce a deviation in the flow velocity of the air flowing through the mixing flow path 46, depending on the position in the circumferential direction of the first mixing flow path 461.

As shown in FIGS. 12A to 12C, when the extending directions of a linear portion 121A and a linear portion 121B which are adjacent to each other are different, and the linear portion 121A and the linear portion 121B which are adjacent to each other form a corner portion, a secondary flow at the corner portion may affect the flow of the air to the mixing flow path 46, thereby creating a possibility that an undesirable deviation in a fuel concentration occurs inside the mixing flow path 46. Therefore, when the extending directions of the linear portion 121A and the linear portion 121B which are adjacent to each other are different as shown in FIGS. 12A to 12C, the linear portion 121A and the linear portion 121B which have different extending directions may be smoothly connected to each other by a curved surface 121C. In this manner, the undesirable deviation in the fuel concentration inside the mixing flow path 46 can be reduced, and the risk of flashback can be reduced.

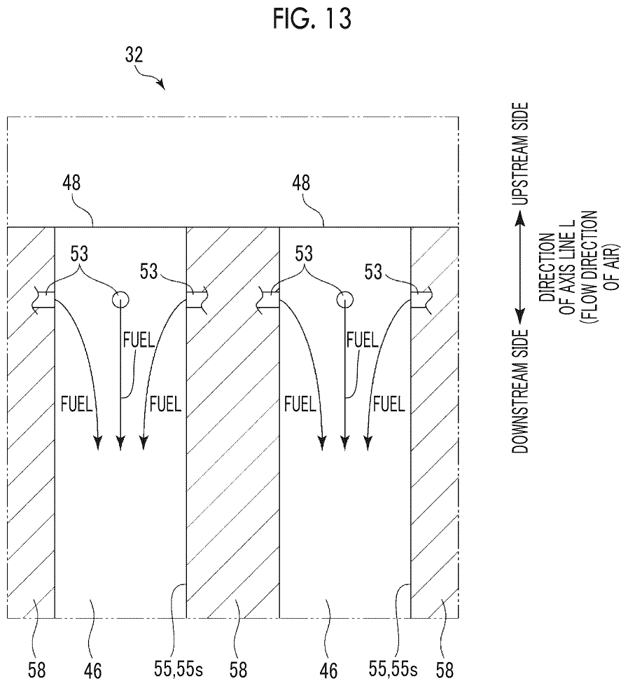

FIG. 13 is a view showing an example of the burner assembly 32 when the fuel is injected on the downstream side of the inlet 48 of the mixing flow path 46.

In some embodiments described above, the fuel is injected on the upstream side of the inlet 48 of the mixing flow path 46, but as shown in FIG. 13, the fuel injection hole 53 may be provided in the mixing flow path 46 on the downstream side of the inlet 48, and the fuel may be injected into the mixing flow path 46 from the fuel injection hole 53.

As shown in FIG. 13, when the fuel injection hole 53 is provided in the mixing flow path 46 on the downstream side of the inlet 48, the protrusion portion 50 may be provided, or may not be provided.

The present disclosure is not limited to the above-described embodiments, and also includes a form in which modifications are added to the above-described embodiments or a form in which the embodiments are combined with each other as appropriate.

For example, in the burner assembly 32 according to some embodiments described above, the inner diameters D of the mixing flow paths 46 may be the same in all of the mixing flow paths 46, and the inner diameters D of some of the mixing flow paths 46 may be different from those of the other mixing flow paths 46.

For example, contents described in each of the above-described embodiments are understood as follows.
(1) The burner assembly 32 according to at least one embodiment of the present disclosure is the burner assembly 32 including the plurality of burners 42 for mixing the fuel and the air. Each of the plurality of burners 42 includes at least one fuel nozzle 43 for injecting the fuel and the mixing flow path 46 through which the fuel injected from the at least one fuel nozzle 43 and the air flow. The burner assembly 32 according to at least one embodiment of the present disclosure includes the first region 101 in which the plurality of the mixing flow paths 46 are collectively disposed when viewed in the extending direction of the mixing flow path 46 (extending direction of the central axis line L), and the second region 102 in which the number of the mixing flow paths 46 per unit area is smaller than that in the first region 101, when viewed in the extending direction of the mixing flow path 46 (extending direction of the central axis line L). The burner assembly 32 according to at least one embodiment of the present disclosure includes the flow guide 120 protruding to the upstream side of the upstream-side end portion (inlet 48) of the flow of the air in the mixing flow path 46 in at least a portion of the region in which the mixing flow path 46 is not present in the second region 102.

According to the configuration of (1) described above, since the flow guide 120 is provided, compared to a case where the flow guide 120 is not provided, the air is guided to flow to each mixing flow path 46 on the further upstream side. Therefore, it is possible to suppress the inward velocity component in the radial direction of the mixing flow path 46 from the inner peripheral surface (wall surface 55s) of the mixing flow path 46 when the air reaches the inlet 48 of the mixing flow path 46, or it is possible to suppress separation of the air from the inner peripheral surface (wall surface 55s) in the region close to the inlet 48 in the mixing flow path 46. In this manner, in the region close to the inner peripheral surface (wall surface 55s) of the mixing flow path 46, the flow velocity of the air in the extending direction is less likely to decrease, and a region having the relatively high fuel concentration is less likely to be formed in the region close to the inner peripheral surface (wall surface 55s) of the mixing flow path 46. Therefore, the risk of flashback, which is backfire from the outlet of the mixing flow path 46, can be reduced.
(2) In some embodiments, in the configuration of (1) described above, the second region 102 may include a region in which a separation distance P between the center position C of the mixing flow path 46 in the two mixing flow paths 46 adjacent to each other when viewed in the extending direction (extending direction of the central axis line L) is equal to or larger than twice the inner diameter D of the mixing flow path 46.

According to the configuration of (2) described above, a region in which the separation distance P between the center position C of the mixing flow path 46 in the two mixing flow paths 46 adjacent to each other when viewed in the extending direction (extending direction of the central axis line L) is equal to or larger than twice the inner diameter D of the mixing flow path 46 is a region in which a size thereof is equal to or larger than the inner diameter D of the mixing flow path 46. Therefore, the mixing flow path 46 can be disposed in the region unless there is another reason. Therefore, the second region 102 is a region in which an interval between the adjacent mixing flow paths 46 is relatively wider than that of the first region 101. Therefore, since the flow guide 120 is provided in the second region 102 in which the interval between the adjacent mixing flow paths 46 is relatively wider than that of the first region 101, the flow guide 120 can be efficiently provided in a region where a high operational effect of the flow guide 120 is expected.
(3) In some embodiments, in the configuration of (1) or (2) described above, the burner assembly 32 may include a plurality of the first regions 101. The second region 102 may include a region between the plurality of first regions 101.

According to the configuration of (3) described above, in the multi-cluster burner having a plurality of segments in which the first region 101 is set as one segment of the cluster burner, the flow guide 120 can be provided in the region between the segments. In this manner, since the flow guide 120 is provided in a dead space between the segments, the risk of flashback in the mixing flow path 46 in the vicinity of the dead space can be reduced.
(4) In some embodiments, in any of the configurations of (1) to (3) described above, the second region 102 may be present inside the first region 101.

According to the configuration of (4) described above, the flow guide 120 can also be provided in the second region 102 present inside the first region 101. In this manner, since the flow guide 120 is provided in the dead space inside the first region 101, the risk of flashback in the mixing flow path 46 in the vicinity of the dead space can be reduced.
(5) In some embodiments, in any of the configurations of (1) to (4) described above, the flow guide 120 may include the linear portion 121 extending in a linear shape along the extending direction (extending direction of the central axis line L). The length Ls of the linear portion 121 in the extending direction (extending direction of the central axis line L) may be equal to or larger than 0.5 times the inner diameter D of the mixing flow path 46.

According to the configuration of (5) described above, since the air can be effectively rectified by the flow guide 120, the risk of flashback can be effectively reduced.
(6) In some embodiments, in the configuration of (5) described above, the flow guide 120 may include the linear portion 121, and the tip portion 123 formed such that the dimension Xf in the direction orthogonal to the extending direction (extending direction of the central axis line L) decreases toward the upstream side on the upstream side of the linear portion 121.

According to the configuration of (6) described above, since the flow guide 120 includes the tip portion 123, the air can be more effectively rectified. Therefore, the risk of flashback can be effectively further reduced.
(7) In some embodiments, in the configuration of (6) described above, in the cross section taken along the extending direction (extending direction of the central axis line L), the distance H in the extending direction (extending direction of the central axis line L) from the top portion 125 located on the most upstream side in the tip portion 123 to the position 122 on the most upstream side in the linear portion 121 may be equal to or larger than the distance Wf in the direction orthogonal to the extending direction (extending direction of the central axis line L) from the top portion 125 to the linear portion 121 when viewed in the extending direction (extending direction of the central axis line L).

According to the configuration of (7) described above, the length of the tip portion 123 in the extending direction (extending direction of the central axis line L) can be secured, and the inward velocity component in the radial direction of the mixing flow path 46 in the air flowing along the surface 123a of the tip portion 123 from the tip portion 123 to the linear portion 121 can be reduced. Therefore, the risk of flashback can be reduced.
(8) In some embodiments, in any of the configurations of (5) to (7) described above, the distance al between the linear portion 121 and the first inner peripheral surface 551s of the first mixing flow path 461 adjacent to the linear portion 121 when viewed in the extending direction (extending direction of the central axis line L) may be equal to or larger than 0.4 times and equal to or smaller than 0.6 times the distance a2 between the first inner peripheral surface 551s and the second inner peripheral surface 552s of the second mixing flow path 462 adjacent to the first mixing flow path 461.

According to the configuration of (8) described above, the distance al between the linear portion 121 and the first inner peripheral surface 551s of the first mixing flow path 461 adjacent to the linear portion 121 is equal to or larger than 0.4 times and equal to or smaller than 0.6 times the distance a2 between the first inner peripheral surface 551s and the second inner peripheral surface 552s of the second mixing flow path 462 adjacent to the first mixing flow path 461 when viewed in the extending direction (extending direction of the central axis line L). Therefore, it is possible to reduce a deviation in the flow velocity of the air flowing through the mixing flow path 46 due to the position of the first mixing flow path 461 in the circumferential direction.
(9) In some embodiments, in any of the configurations of (1) to (8) described above, the burner assembly 32 may have a circular shape around the central axis (central axis line L) parallel to the extending direction (extending direction of the central axis line L). The flow guide 120 may have different protruding amounts Hf to the upstream side, depending on the position in the radial direction around the central axis (central axis line L).

According to the configuration of (9) described above, the protruding amount Hf to the upstream side can be appropriately adjusted, depending on the position in the radial direction around the central axis (central axis line L).
(10) The gas turbine combustor (combustor 4) according to at least one embodiment of the present disclosure includes the burner assembly 32 having any of the configurations of (1) to (9) described above, and the combustion cylinder 25 forming a space in which a flame is formed on the downstream side of the burner assembly 32.

According to the configuration of (10) described above, since the burner assembly 32 of any one of the configurations of (1) to (9) is provided, the risk of flashback can be suppressed. Therefore, the gas turbine combustor (combustor 4) can be stably used.
(11) The gas turbine 1 according to at least one embodiment of the present disclosure includes the compressor 2, the gas turbine combustor (combustor 4) to which the air compressed by the compressor 2 and the fuel are supplied, and configured to generate the combustion gas by combusting the fuel, and the turbine 6 driven by the combustion gas generated in the gas turbine combustor (combustor 4). The gas turbine combustor (combustor 4) is the gas turbine combustor (combustor 4) having the configuration of (10) described above.

According to the configuration of (11) described above, since the gas turbine combustor (combustor 4) having the configuration of (10) is provided, the risk of flashback can be suppressed, and the gas turbine 1 can be stably operated.

### Reference Signs List

1: gas turbine
2: compressor
4: combustor (gas turbine combustor)
6: turbine
8: rotor
25: combustion cylinder
32: burner assembly
42: burner
43: fuel nozzle
46: mixing flow path
48: inlet
50: protrusion portion
53: fuel injection hole
55: flow path wall
55s: wall surface
58: bulkhead portion
101: first region
102: second region
120: flow guide
121: linear portion
122: position
123: tip portion
125: top portion
461: first mixing flow path
462: second mixing flow path
551s: first inner peripheral surface
552s: second inner peripheral surface

1. A burner assembly comprising:
a plurality of burners for mixing a fuel and air,
wherein each of the plurality of burners includes
at least one fuel nozzle for injecting the fuel, and
a mixing flow path through which the fuel injected from the at least one fuel nozzle and the air flow,
when viewed in an extending direction of the mixing flow paths, the burner assembly includes a first region in which a plurality of the mixing flow paths are collectively disposed, and a second region in which the number of the mixing flow paths per unit area when viewed in the extending direction is smaller than the number of the mixing flow paths per unit area in the first region, and
the burner assembly includes a flow guide protruding to an upstream side of an upstream-side end portion of a flow of the air in the mixing flow path in at least a portion of a region in which the mixing flow path is not present in the second region.

2. The burner assembly according to claim 1,
wherein the second region includes a region in which a separation distance between center positions of mixing flow paths in two mixing flow paths adjacent to each other when viewed in the extending direction is equal to or larger than twice an inner diameter of the mixing flow path.

3. The burner assembly according to claim 1,
wherein the burner assembly includes a plurality of the first regions, and
the second region includes a region between the plurality of first regions.

4. The burner assembly according to claim 1,
wherein the second region is present inside the first region.

5. The burner assembly according to claim 1,
wherein the flow guide includes a linear portion extending in a linear shape along the extending direction, and
a length of the linear portion along the extending direction is equal to or larger than 0.5 times an inner diameter of the mixing flow path.

6. The burner assembly according to claim 5,
wherein the flow guide includes
the linear portion, and
a tip portion formed such that a dimension in a direction orthogonal to the extending direction decreases toward the upstream side on the upstream side of the linear portion.

7. The burner assembly according to claim 6,
wherein in a cross section taken along the extending direction, a distance in the extending direction from a top portion located on a most upstream side in the tip portion to a position on a most upstream side in the linear portion is equal to or larger than a distance in a direction orthogonal to the extending direction from the top portion to the linear portion when viewed in the extending direction.

8. The burner assembly according to claim 5,
wherein a distance between the linear portion and a first inner peripheral surface of a first mixing flow path adjacent to the linear portion when viewed in the extending direction is equal to or larger than 0.4 times and equal to or smaller than 0.6 times a distance between the first inner peripheral surface and a second inner peripheral surface of a second mixing flow path adjacent to the first mixing flow path.

9. The burner assembly according to claim 1,
wherein the burner assembly has a circular shape around a central axis parallel to the extending direction, and
in the flow guide, a protruding amount to the upstream side varies depending on a radial position around the central axis.

10. A gas turbine combustor comprising:
the burner assembly according to claim 1; and
a combustion cylinder forming a space in which a flame is formed on a downstream side of the burner assembly.

11. A gas turbine comprising:
a compressor;
a gas turbine combustor to which air compressed by the compressor and a fuel are supplied, and configured to generate a combustion gas by combusting the fuel; and
a turbine driven by the combustion gas generated in the gas turbine combustor,
wherein the gas turbine combustor is the gas turbine combustor according to claim 10.
